(19) United States
(12) Patent Application Publication
(10) Pub. No.: US 2005/0177778 A1
(43) Pub. Date: Aug. 11, 2005

(54) Error simulation for a memory module

(76) Inventors: Nicholas Holian, Houston, TX (US); Jarrod P. Brensel, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/763,693

(22) Filed: Jan. 23, 2004

(51) Int. Cl. G06F 11/00

(52) U.S. Cl. 714/42

(57) ABSTRACT

A memory module that comprises a plurality of memory circuits, a plurality of data lines that transfer data to and from the memory circuits, and a switching device coupled to at least one of the plurality of data lines is disclosed. The switching device selectively operates to simulate a hardware error on the at least one of the plurality of data lines based on an input signal from a control logic external to the memory module.

### BACKGROUND

Computer systems, for example home computers or high-end computers operated as servers, may utilize memory to store data. The memory may comprise one or more memory modules that are connected together via a memory bus. The memory bus may utilize a signaling convention that facilitates the transfer of data between devices connected to the bus. The devices may comprise memory devices, data converters, and remote input/output ports.

To ensure that the memory associated with a computer system is functioning properly, an error detection mechanism within the computer system's chipset may monitor memory transactions and detect memory errors caused by hardware errors, for example stuck-at-1 faults (a data line stuck at a high voltage), stuck-at-0 faults (a data line stuck at a low voltage or grounded condition), and stuck-open faults (a data line driven neither high nor low, where the voltage on the data line therefore electrically floats).

To validate and test the error detection mechanism, hardware errors may be simulated on the data lines of a memory module. With memory bus speeds increasing, it may be difficult to reliably simulate hardware errors for the purpose of testing and validating the error detection mechanism.

### SUMMARY

The problems noted above may be solved in large part by a memory module that simulates hardware errors. One exemplary embodiment may be a memory module that comprises a plurality of memory circuits, a plurality of data lines that transfer data to and from the memory circuits, and a switching device coupled to at least one of the plurality of data lines. The switching device selectively operates to simulate a hardware error on the at least one of the plurality of data lines based on an input signal from a control logic external to the memory module.

### BRIEF DESCRIPTION OF THE DRAWINGS

For a detailed description of exemplary embodiments of the invention, reference will now be made to the accompanying drawings in which:

FIG. 1 illustrates a computer system constructed in accordance with embodiments of the invention;

FIG. 2 illustrates a memory module constructed in accordance with embodiments of the invention;

FIG. 3A illustrates a first exemplary configuration of the switching device of FIG. 2 in accordance with embodiments of the invention;

FIG. 3B illustrates a second exemplary configuration of the switching device of FIG. 2 in accordance with embodiments of the invention;

FIG. 4 illustrates a flow diagram of an error simulation procedure in accordance with embodiments of the invention; and

FIG. 5 illustrates the logic of FIG. 2 in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the verb “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. The embodiments disclosed should not be interpreted, or otherwise used, as limiting the scope of the disclosure unless otherwise specified. In addition, one skilled in the art will understand that the following description has broad application, and the discussion of any embodiment is meant only to be exemplary of that embodiment, and not intended to intimate that the scope of the disclosure is limited to that embodiment.

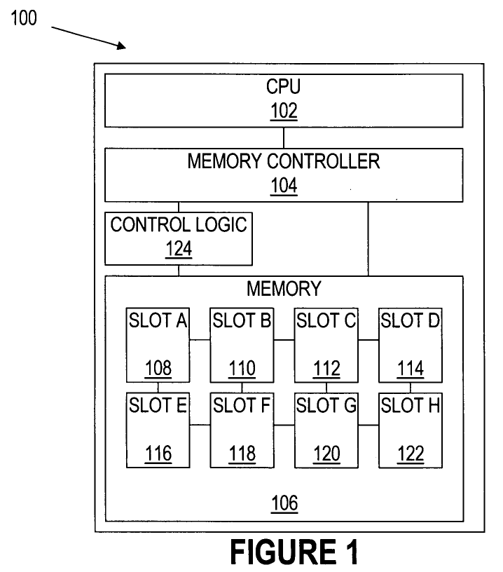

FIG. 1 illustrates an exemplary computer system constructed in accordance with embodiments of the invention. System 100 may be any type of computer system, such as a laptop computer, a personal computer, or stand-alone computer operated as a server. The system 100 may comprise a single central processing unit (CPU) 102, as illustrated in FIG. 1, or may comprise a plurality of CPUs arranged in a configuration where parallel computing may take place. The CPU 102 may couple to a memory controller 104 that manages a memory 106.

The memory 106 may comprise one or more memory slots, each slot designed to interface with a memory module, such as a dual inline memory module (DIMM). Although any number of memory slots may be used, eight memory slots 108-122 are illustrated in the memory 106. Each memory slot 108-122 may interface with a memory module (not specifically shown in FIG. 1) that may comprise any type of memory circuit, such as double data rate (DDR), fast page mode (FPM), and extended data out (EDO). The memory slots 108-122 may be coupled together and to the memory controller 104 via a memory bus (not specifically shown) that facilitates the transfer of data between the memory slots 108-122 and the memory controller 104. In addition, control logic 124 may be coupled to the memory controller 104 and the memory 106. The control logic 124 may be a programmable logic array (PLA), a programmable logic device (PLD), or any other logic component capable of communicating with the memory 106 to simulate hardware errors.

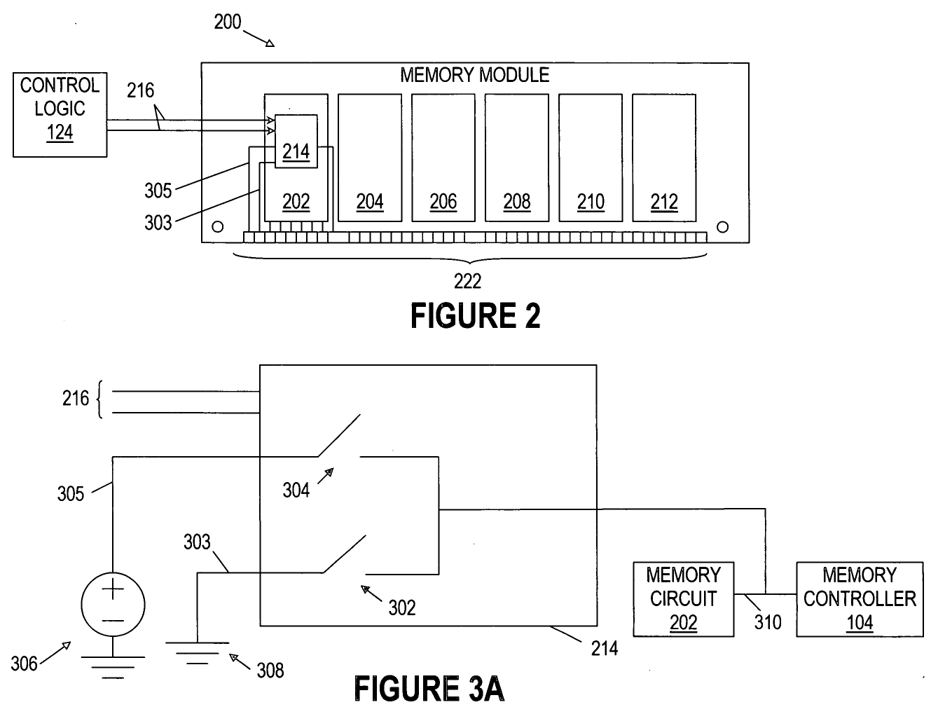

Referring now to FIG. 2, an exemplary memory module is shown in accordance with embodiments of the invention. The memory module 200 may comprise one or more memory circuits that are capable of storing data. Although any number of memory circuits may be used, six memory circuits 202-212 are illustrated in the memory module 200.

Data may be transferred to and from the memory circuits 202-212 via a plurality of data lines. Each data line may couple to one or more input/output (I/O) pins 222 that interface the memory module 200 with one of the memory slot 108-122 (FIG. 1). For example, a DIMM may possess 168 total I/O pins, 64 of which are coupled to distinct data lines. The pins not coupled to a data line may be used for various signals, such as address signals, power signals, ground signals, clock signals, and write strobe signals.

In accordance with embodiments of the invention, a switching device 214 may simulate a hardware error on one or more of the data lines in the memory module 200. The switching device 214 may attach to the memory module 200 at any suitable location. In accordance with embodiments of the invention, the attachment point may be selected such that the length of the wire or wires needed to couple the switching device 214 to the one or more data lines is minimized. By reducing the length of wire needed to couple the switching device 214 to the data lines, hardware errors may be more reliably simulated from the switching device 214. As shown in FIG. 2, the switching device 214 is attached to an outer surface of one of the memory circuits 202-212, for example held in place on an outer surface of a packaged memory circuit by expoxy. The switching device 214 may be any type of switching device, for example IDT's QuickSwitch® QS3306A. The control logic 124 may couple to the switching device 214 via one or more enable lines 216.

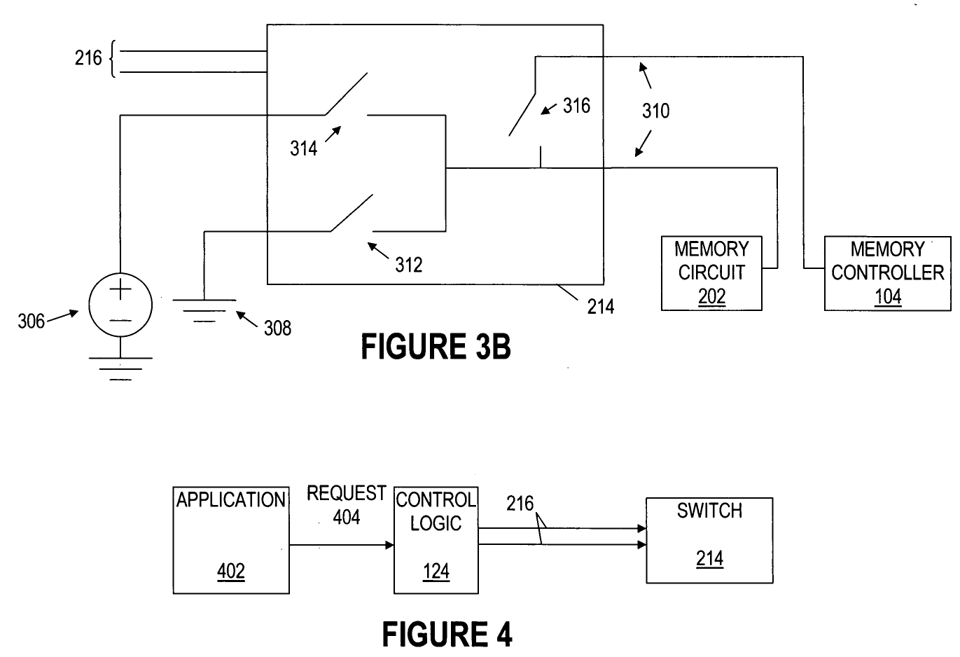

FIG. 3A illustrates the switching device 214 in accordance with at least some embodiments of the invention. The switching device 214 may comprise two switching units 302 and 304. Although mechanical switches are shown in FIG. 3A, the switching units 302 and 304 may be any type of switching device, for example bipolar transistors or metal oxide semiconductor field effect transistors (MOSFETs). The switching unit 302 may couple to ground 308 through line 305, for example via one or more I/O pins 222 (FIG. 2). The switching unit 304 may couple to a power source 306 through line 303, for example via one or more I/O pins 222. The output signal of the switching device 214 may couple to the one or more data lines 310 in which a simulated hardware error is to take place. The enable lines 216 from the control logic 124 (FIG. 2) may control operation of the switching units 302 and 304.

In the exemplary embodiments of FIG. 3A, the state of the switching units 302 and 304 may be controlled by the combined states of the enable lines 216. When the switching unit 304 is conducting and the switching unit 302 is not conducting, the data line 310 may be driven to a high voltage level, representing a stuck-at-1 fault on the data line 310. When the switching unit 304 is not conducting and the switching unit 302 is conducting, the data line 310 may be driven to a low voltage level or a grounded condition, representing a stuck-at-0 fault on the data line 310. Thus, the switching device 214 as illustrated in FIG. 3A is capable of selectively driving the data line 310 to a high and low voltage level.

FIG. 3B illustrates alternative embodiments of the switching device 214. In the alternative embodiments, the switching device 214 may comprise three switching units 312, 314, and 316. Although mechanical switches are shown in FIG. 3B, the switching units 312, 314, and 316 may be any type of switching device, for example bipolar transistors or MOSFETs. The switching unit 312 may couple to the ground 308, and the switching unit 314 may couple to the power source 306. The leads of the switching device 214 may electrically couple in series between the memory controller 104 and the memory circuit 202 to simulate the hardware errors in the memory module 200 (FIG. 2). Thus, the embodiments of FIG. 3B can simulate not only stuck-at-0 and stuck-at-1 hardware errors, but may also, by selective activation of the various switching units, simulate a stuck-open hardware error. The enable lines 216 from the control logic 124 (FIG. 2) may control the switching units 312, 314, and 316.

Still referring to the embodiments illustrated by FIG. 3B, when hardware errors are not being simulated, the switching unit 316 is conducting and the switching units 312 and 314 are not conducting. When the switching units 314 and 316 are conducting, and the switching unit 312 is not conducting, the data line 310 may be driven to a high voltage level, representing a stuck-at-1 hardware error. When the switching units 312 and 316 are conducting, and the switching unit 314 is not conducting, the data line 310 may be driven to a low voltage level, representing a stuck-at-0 hardware error. When the switching units 312, 314, and 316 are not conducting, the data line 310 may electrically float, representing a stuck-open hardware error. Thus, the switching device 214 is capable of driving the data line 310 to a high voltage level, driving the data line 310 a low voltage level or ground condition, and electrically floating the data line 310.

FIG. 4 shows the relationship between an application 402, the control logic 124, and the switching device 214. An application 402 executed by the CPU 102 (FIG. 1) may provide an interface to the control logic 124. The application 402 may utilize a basic input/output system (BIOS) call, a high-level driver, or any other means of accessing the control logic 124, such as an In-System Programming (ISP) header, to send a request 404 to the control logic 124. The request 404 may seek the simulation of one or more hardware errors, such as stuck-at faults and stuck-open faults. In addition, the request 404 may represent the location in embodiments where hardware errors may be simulated on multiple data lines (possibly by multiple switching devices 214) and duration of such hardware errors. Thus, the location may represent the data line or date lines on which to simulate a hardware error, and the duration may represent the amount of time the hardware error is to be simulated. The control logic 124 may receive the request 404 and responsive to the request 404 selectively assert the enable lines 216.

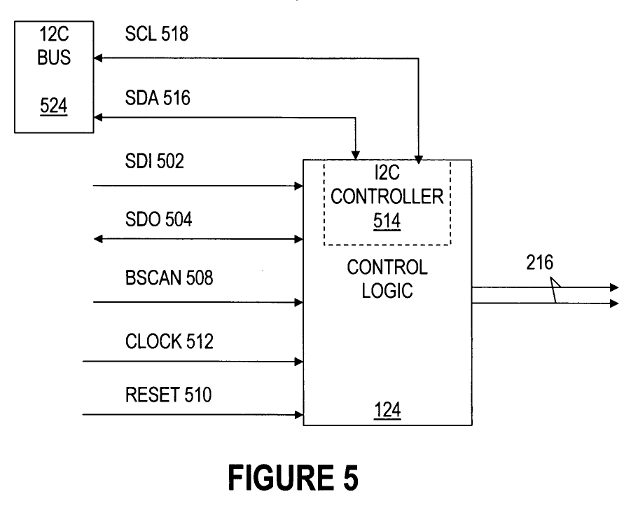

Referring now to FIG. 5, an exemplary configuration of the control logic 124 is shown in accordance with at least some embodiments of the invention. The control logic 124 may comprise a serial data in (SDI) 502 line, a serial data out (SDO) 504 line, and a boundary scan (BSCAN) 508 line. The control logic 124 may be programmed by grounding (i.e., setting to a low voltage value) the BSCAN 508 line and transferring data into the control logic 124 via the SDI 502 line. The request 404 (FIG. 4) may be transferred to the control logic 124 via the SDI 502 line. Other inputs to the control logic 124, such as a reset 510 line and a clock 512 line, may be used. The control logic 124 may couple to the switching device 214 of FIG. 2 via the enable lines 216, as previously discussed. The enable lines 216 may control the switching device 214, which is responsible for simulating the hardware errors on the data lines of the memory module 200. In addition, one or more bus controllers, such as an inter-integrated circuits (I²C) controller 514, that facilitate the transfer of data and commands from the application 302 (FIG. 3) to the control logic 124 may also be associated with the control logic 124. For example, the control logic 124 may be coupled to and operating on an I²C bus 524. The logic 214 may utilize a serial data (SDA) 516 line and a serial clock (SCL) 518 line to transfer data bi-directionally between the I²C controller 514 and the I²C bus 524. The request 404 may be transferred to the control logic 124 via the 1²C bus 524.

The control logic 124 may perform functions associated with hardware error simulation. For example, the control logic 124 may maintain a counter of the number of hardware errors to be simulated on the data lines of the memory module 200. In addition, the control logic may maintain a timer associated with the duration of the hardware errors to be simulated in the memory module 200.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A memory module comprising,
a plurality of memory circuits;
a plurality of data lines coupled to the plurality of memory circuits, the plurality of data lines transfer data to and from the plurality of memory circuits;
a switching device coupled to at least one of the plurality of data lines; and
wherein the switching device selectively operates to simulate a hardware error on at least one of the plurality of data lines based on an input signal from a control logic external to the memory module.

2. The memory module of claim 1 wherein the memory circuits are packaged memory circuits, and wherein the switching device is attached to an outer surface of the package of one of the plurality of memory circuits.

3. The memory module of claim 1 wherein the switching device electrically floats the at least one of the plurality of data lines.

4. The memory module of claim 1 wherein the switching device drives the at least one of the plurality of data lines to a high voltage level.

5. The memory module of claim 1 wherein the switching device drives the at least one of the plurality of data lines to a low voltage level.

6. A method comprising:
receiving a request by a control logic to simulate a hardware error on a data line of a memory module; and
simulating the hardware error on the data line by a switching unit on the memory module.

7. The method of claim 6 further comprising sending instructions to inject the error to the control logic from an application executing in a computer system coupled to the memory module.

8. The method of claim 7 comprising sending the instructions on a communication bus.

9. The method of claim 8 comprising sending the instructions on an inter-integrated circuits (I²C) communications bus.

10. The method of claim 6 wherein simulating the hardware error comprises driving a high voltage on the data line in the memory module to simulate a stuck-at-1 hardware error.

11. The method of claim 6 wherein simulating the hardware error comprises electrically floating a data line in the memory module to simulate a stuck-open hardware error.

12. The method of claim 6 wherein simulating the hardware error comprises electrically grounding the data line in the memory module to simulate a stuck-at-0 fault.

13. The method of claim 6 wherein simulating the hardware error comprises simulating a hardware error for a predetermined amount of time, the simulated hardware error being one selected from the group consisting of a stuck-at-1 hardware error, a stuck-at-0 hardware error, and a stuck-open hardware error.

14. A system comprising:
a central processing unit (CPU);
a memory coupled to the CPU;
control logic coupled to the memory and operable to enable operation of a switching device coupled to a memory module to simulate a hardware error in the memory module.

15. The system of claim 14 wherein the switching device is operable to apply a high voltage level to a data line in the memory module.

16. The system of claim 14 wherein the switching device is operable to apply a low voltage level to a data line in the memory module.

17. The system of claim 14 wherein the switching device electrically floats a data line in the memory module.

18. The system of claim 14 wherein the control logic initializes and maintains a counter of the number of hardware errors to simulate in memory module.

19. The system of claim 14 wherein the control logic initializes and maintains a timer of the duration of hardware errors to simulate in the memory module.

20. A system comprising:
a plurality of means for storing data, wherein at least one the means for storing data is integrated with a means for driving a simulated hardware error;
a plurality of means for transferring data to and from the plurality of means for storing data; and
wherein the means for driving is operable to one of drive a voltage and electrically float at least one of the plurality of means for transferring data.

21. The system of claim 20 wherein the means for driving applies a voltage based on a request from a software application.

22. The system of claim 20 wherein the means for driving further comprises a means for interfacing with a communications bus.
